(19) United States
(12) Patent Application Publication
(10) Pub. No.: US 2024/0340569 A1
(43) Pub. Date: Oct. 10, 2024

(54) Tragus Clipping Earphone

(71) Applicant: Yuanhao Liu, Shenzhen (CN)

(72) Inventor: Yuanhao Liu, Shenzhen (CN)

(21) Appl. No.: 18/241,902

(22) Filed: Sep. 4, 2023

(30) Foreign Application Priority Data
Apr. 6, 2023 (CN) 2023103977879
Jun. 20, 2023 (CN) 2023107372413

(51) Int. Cl. H04R 1/10

(52) U.S. Cl. CPC H04R 1/1016; H04R 1/1041; H04R 1/105; H04R 1/1075

(57) ABSTRACT

A tragus clipping earphone includes an cavum conchae wearing portion for being placed at an inner side of the wearer's tragus and a tragus clipping portion for being fitted on an outer side of the wearer's tragus, so as to reduce hearing damage to the wearer. The tragus clipping portion is extended from the cavum conchae wearing portion with a predetermined angle, a clipping space is formed between the cavum conchae wearing part and the tragus clip part for clipping the wearer's tragus to ensure the wearing stability of the tragus clipping earphone.

### CROSS REFERENCE OF RELATED APPLICATION

This application is a non-provisional application that claims priority under 35U.S.C. § 119 to China application number CN202310737241.3, filing date Jun. 20, 2023 and China application number CN202310397787.9, filing date Apr. 6, 2023, wherein the entire content of which is expressly incorporated herein by reference.

### BACKGROUND OF THE PRESENT INVENTION

### Field of Invention

The present invention relates to the field of electronic device and earphone, and more particularly to a tragus clipping earphone.

### Description of Related Arts

Earphones are commonly used in our daily lives to receive electrical signals from media players or receivers and convert them into audible sound waves using speakers which are closed to the ear. Headphones have been developed for hundreds of years, starting with the first moving-iron headphones in 1910 and continuing with the wide range of headphones available today.

Currently, the types of earphones on the market are headset earphones, small in-ear headphones and over-ear headphones. Various types of earphones have different disadvantages. Although headset earphones have better sound quality and noise isolation effect as well as a cooler design, they are easy to compress the ears and the top of the head when wearing for a long term, harm the hearing of the user. And on some occasions, if you can't hear the outside environment noise, it is easy to cause accidents. In addition, they are not easy to store because of their sizes, and when the weather is hot, the wearer sweats easily, causing damage to the headphones.

In-ear headphones, although small and convenient, but there are shortcomings. On one hand, comfortableness of wearing the in-ear headphones is poor, wearers feel tired when they wear the in-ear headphones for a long time and hearing damage may be caused to the wearers. On the other hand, as in-ear headphones are placed inside the ear, they are prone to result in bacterial growth and unhygienic ear, and when the wearer is exercising with a large amplitude, it is easy to cause the headphones to fall off. Also on some occasions, if you cannot hear the outside environment noise, it is easy to cause accidents. When wearing the over-ear headphones, the over-ear headphones also have the same disadvantages of poor sound performance for listening, painful clamping, easy interference, difficult storage and poor sealing, making the wearer's use experience be far from satisfied.

### SUMMARY OF THE PRESENT INVENTION

The invention is advantageous in that it provides a tragus clipping earphone, wherein the tragus clipping earphone has a clipping space fitted for clipping the tragus of the wearer, and a tragus clipping portion is fitted to an outer side of the tragus of the wearer, so as to greatly increase the stability of the tragus clipping earphone and makes it less likely to slip off, and a cavum conchae wearing portion is placed at an inner side of the tragus, and the open wearing design does not cause hearing damage of the user.

Another advantage of the present invention is that it provides a tragus clipping earphone, wherein the size of the cavum conchae wearing portion of the tragus clipping earphone conforms to the structure of the human cavum conchae and is placed in the cavum conchae of the wearer when in use, so that the tragus clipping earphone can be used regardless of the size of the wearer's ear hole.

Another advantage of the present invention is that it provides a tragus clipping earphone, wherein the control panel and power supply unit of the tragus clipping earphone are located away from the speaker, so that the cavum conchae wearing portion is provided with only the speaker, making the speaker larger in size and better in sound performance.

Another advantage of the present invention is that it provides a tragus clipping earphone, wherein the tragus clipping earphone can be equipped with other intelligent sensors, such as an optical heart rate detecting sensor for measuring the wearer's heart rate, and thus improve depression and adjust the state to make the mood of the wearer be happy.

Another advantage of the present invention is that it provides a tragus clipping earphone, wherein the tragus clipping earphone comprises a hearing aid module, so as to allow the tragus clipping earphone to be incorporated with a hearing aid in order to allow the wear to receive phone calls and listen to others, so as to enable free switching between the two modes in order to avoid the trouble of replacing the earphone with the hearing aid.

Another advantage of the invention is that it provides a tragus clipping earphone, wherein when the tragus clipping earphone is in use, the cavum conchae wearing portion does not need to be completely plugged into the cavum conchae, a speaker is provided in the cavum conchae wearing portion and face towards to the ear canal of the wearer without affecting the sound generation, so as to achieve painless wearing, long time of listening without getting tired, and enhance the use experience of the wearer, it will not affect the listening effect, also will not leak sound, the people around the wear will not hear the sound of the earphone, it will not affect others and privacy will be ensured.

Another advantage of the present invention is that it provides a tragus clipping earphone, wherein the tragus clipping earphone is provided with a communication module which can be used with a smart home appliance and so on, so as to improve the convenience of the wearer's life.

Another advantage of the present invention is that it provides a tragus clipping earphone, wherein the tragus clipping earphone can be made of copper, silver, stainless steel, precious metal and other materials, diamond inlaying, patterning, engraving and other processes can be employed, so that the earphone is decorative, small and exquisite, very ornamental, high degree of beauty, so as to improve the design of the tragus clipping earphone.

Another advantage of the present invention is that it provides a tragus clipping earphone, wherein the cavum conchae wearing portion of the tragus clipping earphone is manufactured by memory flexible material to ensure that the connecting between the tragus clipping earphone and the wearer's ear is soft and does not cause an uncomfortable squeezing feeling to the wearer.

Another advantage of the present invention is that it provides a tragus clipping earphone, wherein the tragus clipping portion of the tragus clipping earphone having a certain elasticity to enlarge the opening of the clipping space easily for the wearer to wear and remove.

Another advantage of the present invention is that it provides a tragus clipping earphone, wherein the tragus clipping earphone is designed ergonomically according to the structure of the human ear with a smaller mass, without pressure and without heaviness, so as to allow the tragus clipping earphone to be better fitted to the tragus and increasing the comfortableness of the wearer.

In accordance with an aspect of the present invention, the present invention further provides a tragus clipping earphone, comprising:
a cavum conchae wearing portion for being placed at a position at an inner side of a tragus of a wearer corresponding to a cavum conchae of the wearer; and
a tragus clipping portion for being fitted on an outer side of the wearer's tragus, wherein the tragus clipping portion is connected to the cavum conchae wearing portion, and a clipping space is formed between the cavum conchae wearing portion and the tragus clipping portion, and the wearer's tragus is adapted to be held in the clipping space and positioned between the cavum conchae wearing portion and the tragus clipping portion.

According to an embodiment of the present invention, the tragus clipping portion comprises a connecting part and a fixing part, two ends of the connecting part are respectively connected to the cavum conchae wearing part and the fixing part, wherein the fixing part is capable of being fitted on the outer side of the tragus of the wearer.

According to an embodiment of the present invention, the fixing part comprises an upper fixing portion and a lower fixing portion, the upper fixing portion is upwardly extended from the cavum conchae wearing portion and the lower fixing portion is downwardly extended from the cavum conchae wearing portion.

According to an embodiment of the present invention, the tragus clipping earphone further comprises a speaker and a power supply unit, the power supply unit is provided in the tragus clipping portion, the speaker is provided in the cavum conchae wearing portion, the speaker is facing towards an ear canal of the wearer when the tragus clipping earphone is worn on the wearer.

According to an embodiment of the present invention, the tragus clipping earphone further comprises a control panel and at least one control button, the control panel is provided in the tragus clipping portion and the control button is provided on an outer surface of the tragus clipping portion.

According to an embodiment of the present invention, the tragus clipping earphone further comprises a speaker and a control panel, the speaker and the control panel are provided in the cavum conchae wearing portion, the speaker is facing towards the ear canal of the wearer when the tragus clipping earphone is worn on the wearer.

According to an embodiment of the present invention, the tragus clipping earphone further comprises a communication module which is disposed in the tragus clipping portion, the communication module is electrically connected to the power supply unit and the control panel.

According to an embodiment of the present invention, the tragus clipping portion is made of elastic material or rigid material.

According to an embodiment of the present invention, the tragus clipping earphone further comprises a microphone which is provided on the tragus clipping portion.

According to an embodiment of the present invention, the cavum conchae wearing portion comprises a body portion and a cover portion, the cover portion is detachably mounted to the body portion, the body portion is connected to the tragus clipping portion.

According to an embodiment of the present invention, the tragus clipping earphone further comprises a decorative unit which is mounted on at least one of the body portion of the cavum conchae wearing portion and the tragus clipping portion.

According to an embodiment of the present invention, the tragus clipping earphone, further comprises a hearing aid module such that the tragus clipping earphone combines the function of a hearing aid with the function of an earphone.

According to an embodiment of the present invention, the tragus clipping earphone is configured as a terminal device for intelligent voice interaction.

According to an embodiment of the present invention, the tragus clipping earphone further comprises a speaker and a control panel, wherein the speaker is provided in the cavum conchae wearing portion, the speaker is facing towards an ear canal of the wearer when the tragus clipping earphone is worn on the wearer, the control panel is provided in the tragus clipping portion.

According to an embodiment of the present invention, the power supply unit is provided in one of the cavum conchae wearing portion and the tragus clipping portion.

According to an embodiment of the present invention, the connecting part comprises wires and a connection slot, wherein the wires are disposed in the connecting slot.

According to an embodiment of the present invention, the connection slot is recessed along the connecting part, wherein the wires disposed in the connecting slot are exposed.

According to an embodiment of the present invention, the decorative unit comprises a plurality of dotted decorations or a strip of decorations which is provided by a diamond inlaying process or an engraving process.

According to an embodiment of the present invention, the body portion and the tragus clipping portion is made of a material selected from the group consisting of copper, silver, stainless steel, K-gold and gold, wherein the tragus clipping earphone further comprises a decorative unit which is mounted on at least one of the body portion of the cavum conchae wearing portion and the tragus clipping portion.

According to an embodiment of the present invention, the body portion and the tragus clipping portion is made of a material selected from the group consisting of copper, silver, stainless steel, K-gold, gold, ABS material, PP material, PC material, rubber, and silicone

Further objects and advantages of the present invention will be fully realized by an understanding of the subsequent description and the accompanying drawings.

### BRIEF DESCRIPTION OF THE DRAWINGS

FIG. 1 is a perspective view illustrating an overall structure of a tragus clipping earphone according to a first preferred embodiment of the present invention.

FIG. 2 is a schematic view illustrating the tragus clipping earphone being in a wearing state according to the above first preferred embodiment of the present invention.

FIG. 3 is a schematic view illustrating an application scenario of the tragus clipping earphone according to the above first preferred embodiment of the present invention.

FIG. 4 is a schematic view illustrating the distribution of the decorative units of the tragus clipping earphone according to the above first preferred embodiment of the present invention.

FIG. 5 is a perspective view illustrating an overall structure of a tragus clipping earphone according to a second preferred embodiment of the present invention.

FIG. 6 is a perspective view illustrating an overall structure of a tragus clipping earphone according to a third preferred embodiment of the present invention.

FIG. 7 is a perspective view illustrating an overall structure of a tragus clipping earphone according to a fourth preferred embodiment of the present invention.

FIG. 8 is a perspective view illustrating an overall structure of a tragus clipping earphone according to a fifth preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. that indicate relations of directions or positions are based on the relations of directions or positions shown in the appended drawings, which are only to facilitate descriptions of the present invention and to simplify the descriptions, rather than to indicate or imply that the referred device or element is limited to the specific direction or to be operated or configured in the specific direction. Therefore, the above-mentioned terminologies shall not be interpreted as confine to the present invention.

It should be understood that the term “a” or “an” should be understood as “at least one” or “one or more”, that is, in one embodiment, the quantity of a component can be one, while in another embodiment, the quantity of the component can be more than one. The term “a” or “an” should not be understood as limiting the quantity

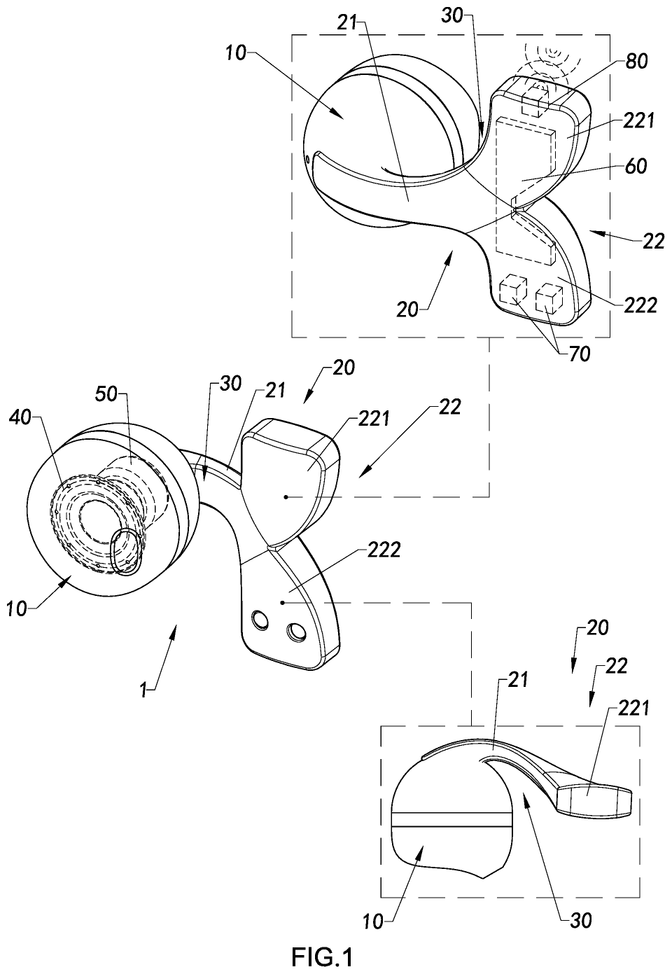

Referring to FIGS. 1 to 4 of the drawings, a tragus clipping earphone according to a first preferred embodiment of the present invention is illustrated. The tragus clipping earphone 1 receives an electrical signal from a media player or receiver and converts it into audible sound waves using a speaker which is closed to the ear.

For the purpose of illustration, in this embodiment, an end of the tragus clipping earphone 1 that is placed into the cavum conchae 801 during use is referred to as a front end of the tragus clipping earphone 1, and the end opposite the front end of the tragus clipping earphone 1 is referred to as a rear end of the tragus clipping earphone 1. A side of the tragus clipping earphone 1 near the wearer's cavum conchae 801 is defined as an inner side of the tragus clipping earphone 1, and the side away from the wearer's cavum conchae 801 is defined as an outer side of the tragus clipping earphone 1.

FIG. 1 is a perspective view illustrating an overall structure of the tragus clipping earphone 1 according to a first preferred embodiment of the present invention. In this embodiment, the tragus clipping earphone 1 comprises a cavum conchae wearing portion 10, an tragus clipping portion 20 and has a clipping space 30, the tragus clipping portion 20 is provided at a rear end of the cavum conchae wearing portion 10, the cavum conchae wearing portion 10 is adapted to fit at an inner side of the tragus 802 of the wearer, the tragus clipping portion 20 is adapted to fit on the outside of the tragus 802 of the wearer, the clipping space 30 is formed between the cavum conchae wearing portion 10 and the tragus clipping portion 20, the tragus 802 of the wearer is placed into the clipping space 30 when the tragus clipping earphone 1 is in use, thereby allowing the tragus clipping earphone 1 to be retained to the wearer's ear.

The tragus clipping portion 20 comprises a connecting part 21 and a fixing part 22, the fixing part 22 is integrally attached to a rear end of the connecting part 21, the connecting part 21 is attached to an outer side of the cavum conchae wearing portion 10. That is, two sides of the connecting part 21 are respectively connected to the fixing part 22 and the cavum conchae wearing portion 10. Specifically, the connecting part 21 is extended from the outer side of the cavum conchae wearing portion 10 towards the rear end at a predetermined angle, and the clipping space 30 is formed between the cavum conchae wearing portion 10 and the connecting part 21.

The angle between the connecting part 21 and the cavum conchae wearing portion 10 is preferably ranged from 20° to 30° to conform the structure of the tragus 802 of the ear, so that, on one hand, the wearer does not feel discomfort when the tragus 802 of the wearer is placed into the clipping space 30, and on the other hand, the tragus 802 of the wearer can be completely placed into the clipping space 30, to ensure the wearing stability of the tragus clipping earphone 1.

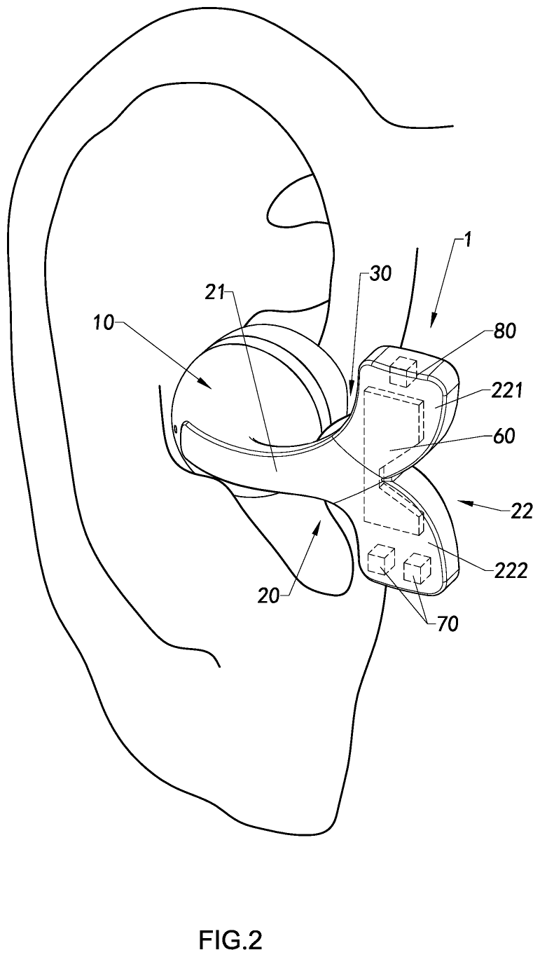

FIG. 2 is a schematic view illustrating the tragus clipping earphone 1 being in a wearing state according to a first preferred embodiment of the present invention. When wearing the tragus clipping earphone 1, the cavum conchae wearing portion 10 is placed at the inner side the tragus 802 of the wearer and its inner side is facing the ear canal, the fixing part 22 is fitted on the outer side of the tragus 802 of the wearer and the tragus 802 of the wearer fitted to the clipping space 30 in a snap fit manner, so that a triangular fixing structure is formed. That is, a stable triangular structure is formed by the cavum conchae wearing portion 10, the fixing part 22 and the connecting part 21, so as to greatly increase the wearing stability of the tragus clipping earphone 1, even when the wearer is exercising vigorously or sweating, the tragus clipping earphone 1 does not slip off easily.

Preferably, the cavum conchae wearing portion 10 is made of a flexible material to ensure a soft contact between the tragus clipping earphone 1 and the wearer's ear without causing an uncomfortable squeezing sensation to the wearer. The tragus clipping portion 20 of the tragus clipping earphone 1 can be made of memory elastic material, such as rubber silicone, so ad to enlarge the opening of the fixing space 30 conveniently and to fix the size of the clipping space 30 for the wearer to wear. In other words, the rear end of the tragus clipping portion 20 is adapted to be toggled to enlarge the size of the fixing space 30, make it easier for the wearer to put on and take off. In other words, the tragus clipping portion 20 is suitable to be made of memory elastic material, which on one hand facilitates the wearing and removal of the tragus clipping earphone 1, and on the other hand makes the tragus clipping portion 20 relatively soft in contact with the wearer's ear, so as to increase the wearing comfortableness.

It is worth mentioning that, in this embodiment, the cavum conchae wearing portion 10 of the tragus clipping earphone 1 conforms to the structure of the human cavum conchae 801 and is placed in the cavum conchae 801 of the wearer when in use, that is, the cavum conchae wearing portion 10 is not completely placed in the cavum conchae 801 of the wearer to seal and block the cavum conchae 801 for achieving positioning, based on this, regardless of the size of the wearer's ear canal, this increases the versatility of the tragus clipping earphone 1 for both elderly and children, as well as for users from different regions, such as African, Americans and Asians.

The tragus clipping earphone 1 is ergonomically designed according to the structure of the human ear, allowing the tragus clipping earphones 1 to be retained on the tragus 802 better, and increasing the comfortableness of the wearer. The tragus clipping earphone 1 does not form a sealed chamber between the cavum conchae wearing portion 10 and the tympanic membrane in the wearer's ear, and thus the tragus clipping earphone 1 is an open wearing earphone which does not cause impact damage to the tympanic membrane in the ear while maintaining good sound quality and does not create a safety hazard by blocking out external environment noise.

In addition, when the tragus clipping earphone 1 is in use, the cavum conchae wearing portion 10 does not need to completely seal off the wearer's cavum conchae 801 to achieve positioning, so as to achieve a painless wear, long time of listening without getting tired, the tragus clipping portion 20 and the wearer's ear contact relatively soft, so as to enhance the wearer's wearing experience.

The fixing part 22 comprises an upper fixing portion 221 and a lower fixing portion 222, the upper fixing portion 221 and the lower fixing portion 222 is integrally connected to the lower end of the connection part 21, the upper fixing portion 221 and the lower fixing portion 222 are the same in length and shape, the upper fixing portion 221 is extended upwardly from the cavum conchae wearing portion 10, the lower fixing portion 222 is extended downwardly from the cavum conchae wearing portion 10, the upper fixing portion 221 and the lower fixing portion 222 enable the tragus clipping earphone 1 to be fixed in a balanced manner at the ear of the wearer, so that they do not fall off even in case of intense exercise or sweating, so as to further improve the wearing stability of the tragus clipping earphone 1.

In this embodiment, the fixing part 22 is provided in the shape of a fishtail, in other embodiments, it can be provided in another shape, for which it should be understood by those skilled in the art that the shape of the fixing part 22 is not a limitation of the present invention.

The cavum conchae wearing portion 10 comprises a body portion 11 and a cover portion 12, the cover portion 12 is detachably mounted to the body portion 11, the cover portion 12 is facing to the ear canal of the wearer when the tragus clipping earphone 1 is worn. The body portion 11 is connected to the connection part 21 of the tragus clipping portion 20. the tragus clipping portion 20 further comprises a decorative unit 201, the decorative unit 201 is mounted on the body portion 11 of the cavum conchae wearing portion 10 and the tragus clipping portion 20 to increase the aesthetics of the tragus clipping earphone 1.

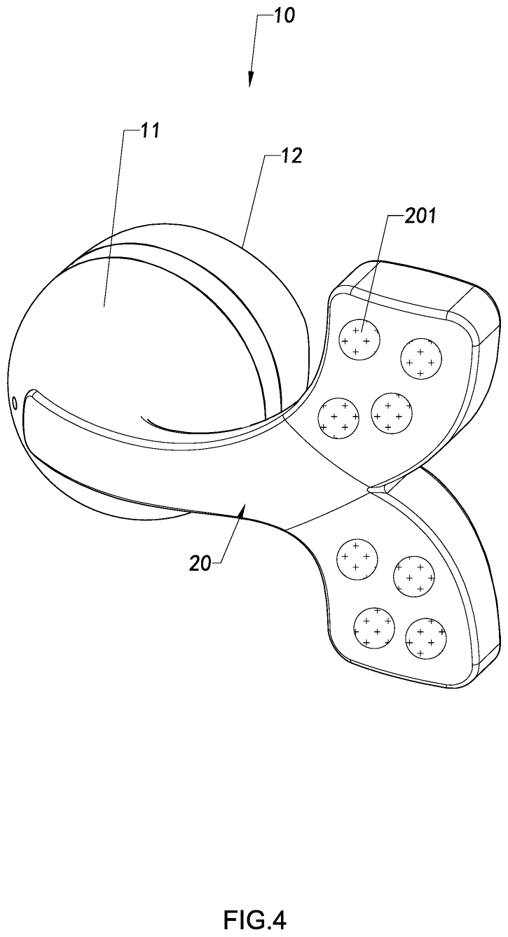

FIG. 4 is a schematic view illustrating a type of distribution of the decorative unit of the tragus clipping earphone according to the above first preferred embodiment of the present invention. Therein, the shape, structure and style of the decorative unit 201 can be changed according to actual and practical needs. For example, the decorative unit 201 can be provided as comprising a plurality of dotted decorations distributed between the body portion 11 and the tragus clipping portion 20. The decorative unit 201 may also be provided as comprising a strip of decorations provided in the tragus clipping portion 20. This is not a limitation of the present invention.

In this embodiment, the body portion 11 of the cavum conchae wearing portion 10 and the connection part 21 of the tragus clipping portion 20 are joined together, in other embodiments, the body portion 11 of the cavum conchae wearing portion 10 and the connection part 21 of the tragus clipping portion 20 may also be provided as a one-piece structure.

Wherein, the body portion 11 of the cavum conchae wearing portion 10 and the tragus clipping portion 20 are preferably manufactured in copper material in order to facilitate the installation of the decorative unit 201 and to give the tragus clipping earphone 1 a decorative character. Alternatively, the body portion 11 and the tragus clipping portion 20 may be manufactured in a material such as silver, stainless steel, precious metals such as K-gold and solid gold, and so on, or a material such as ABS material (Acrylonitrile-Butadiene-Styrene), PP material (Polypropylene), PC material (Polycarbonate), rubber, silicone and so on. The material may be flexible or rigid. Based on this, it should be understood by those skilled in the art that the material of manufacture of the body portion 11 of the cavum conchae wearing portion 10 and the \tragus clipping portion 20 is not a limitation of the present invention.

Furthermore, the cover portion 12 of the cavum conchae wearing portion 10 is preferably manufactured in a material that does not interfere with signal transmission, allowing the tragus clipping earphone 1 to have better sound quality.

The tragus clipping earphone 1 further comprises a speaker 40, a power supply unit 50 and a control panel 60 and at least one control button 70, the speaker 40 is provided in the cavum conchae wearing portion 10, the tragus clipping earphone 1 receives electrical signals from a media player or receiver and converts them into audible sound waves using the speaker 40. The power supply unit 50 is provided inside the cavum conchae wearing portion 10, the control panel 60 is provided inside the fixing part 22 of the tragus clipping portion 20, the control button 70 is provided on the outer surface of the fixing part 22, the control button 70 is exposed when the tragus clipping earphone 1 is in use for easy touch and press by the wearer.

It will be appreciated that, in alternative embodiments, it is also possible to locate the speaker 40 and the control panel 60 in the ear cavum conchae wearing portion 10, the power supply unit 50 and the control buttons 70 are located in the tragus clipping portion 20. Alternatively, the speaker 40 is located in the cavum conchae wearing portion 10, the control panel 60, the power supply unit 50 and the control button 70 are located in the tragus clipping portion 20.

It is worth mentioning that, when the tragus clipping earphone 1 is in use, the cavum conchae wearing portion 10 does not need to be completely placed in the wearer's cavum conchae 801 to position and fix the tragus clipping earphone, the speaker 40 is provided in the cavum conchae wearing portion 10 and facing the wearer's ear canal without affecting the sound, so as to achieve painless wearing and long time of listening, so that the wearer's use experience is enhanced.

The control panel 60, the control button 70 and the power supply unit 50 are electrically connected to each other. During use, the wearer can adjust the volume, switch the channel and switch on and off by touching and pressing the control button 70 with his or her fingers. Specifically, the different adjustments can be achieved by controlling the duration and the number of presses of the control button 70. By pressing the control button 70, the wearer transmits a signal to the control panel 60 for the adjustment of the different functions.

The tragus clipping earphone 1 further comprises a communication module 80, the communication module 80 is provided in the tragus clipping portion 20, the communication module 80 is electrically connected to the control panel 60. Specifically, the communication module 80 is adapted to receive voice signals from the wearer and then transmit them to, for example, the smart home appliance to complete the automatic operation of the smart home appliance.

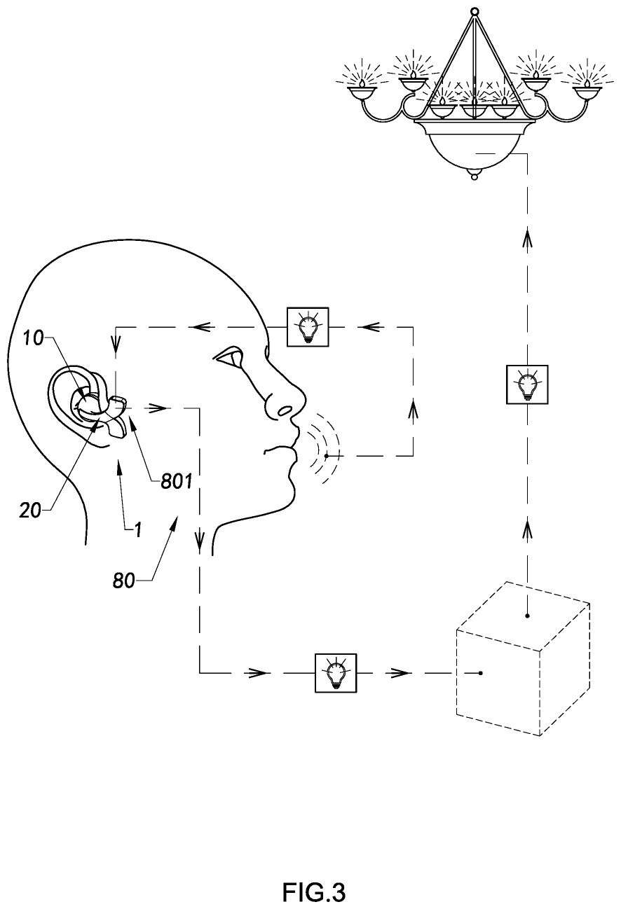

FIG. 3 is a schematic view illustrating an application scenario of the tragus clipping earphone 1 according to the above first preferred embodiment of the present invention. Specifically, the tragus clipping earphone 1 may also be fitted with a microphone 801 for receiving voice commands from the wearer, so that the tragus clipping earphone 1 can be configured with an intelligent interaction module such as an artificial intelligence module, thus acting as a terminal device for intelligent voice interaction, the microphone 801 is electrically connected to the communication module 80. For example, in the morning, the wearer of the tragus clipping earphone 1 sent a voice command “open curtains” to the tragus clipping earphone 1, the communication module 80 of the tragus clipping earphone 1 received the command sent by the wearer and transmits the command “open curtains” to the sensor system of the curtains, the curtains, upon received the signal transmitted by the communication after receiving the signal from the communication module 80, the curtains are opened automatically. In the evening, the wearer of the tragus clipping earphone 1 sent a voice command to the tragus clipping earphone 1 to “turn off the lights”, and the communication module 80 of the tragus clipping earphone 1 received the command output by the wearer and transmits the command to the induction system of the electric lights to “turn off the lights” command, the electric light is automatically switched off after receiving the signal transmitted by the communication module 80. It will be appreciated that the voice interaction here is only used as an example and that the tragus clipping earphone 1 can also be more widely used in various smart interaction scenarios for life and work such as smart home control, smart office, smart call, smart driving, smart medical care, etc.

It is worth mentioning that the microphone 801 can have built-in algorithms to have noise reduction, the microphone 801 can reduce the noise in the environment when it receives voice commands from the wearer, thus allows the microphone 801 to obtain a more pure voice of the wearer.

The tragus clipping earphone 1 is equipped with the communication module 80 which can be used in conjunction with smart homes and so on, so as to improve the convenience of the wearer's life. At the same time the shape is small and delicate, highly ornamental, aesthetically pleasing and enhances the design of the tragus clipping earphone 1.

Conventional headphones have circuit elements such as power supply unit, speaker, control panel and control buttons set relatively centrally together, which makes the speaker of the headphones occupy a small space position and tends to affect the sound quality of the headphones. In this embodiment, the power supply unit 50 is provided inside the cavum conchae wearing portion 10, the speaker 40 is provided within the cavum conchae wearing portion 10, the control panel 60 is provided in the tragus clipping portion 20 and the control button 70 is provided on the outer surface of the tragus clipping portion 20. Based on the distribution of the speaker 40, the power supply unit 50, the control panel 60 and the control button 70, the speaker 40 can take up more space and be larger in size, thus make the sound performance of the tragus clipping earphone 1 better.

It is not a limitation of the invention that the control panel 60 can also be located in the cavum conchae wearing portion 10, and both the power supply unit 50 and the control panel 50 may be located in the tragus clipping portion 20.

It is worth mentioning that the tragus clipping earphone 1 can be equipped with other intelligent sensors, such as an optical heart rate sensor, which can be located in the tragus clipping portion 20 and provided adjacent to the earlobe of the wearer. Accordingly, the light reflected through the skin tissue is received by the photosensitive sensor and converted into an electrical signal which is then converted into a digital signal by AD conversion to measure the heart rate of the wearer.

The tragus clipping earphone 1 can also improve the mood of the wearer. For example, a student who is stressed with his or her studies can be monitored by estimating the student's mood values such as heart rate through the photosensitive sensor and then play preset music or imitate predetermined sound by the tragus clipping earphone 1, thus adjusting and improving the wearer's depressed mood and adjusting the state to make the mood be happy. Parents can also monitor their child's situation via a mobile phone app and thus intervene artificially to prevent bad things from happening.

In addition, the tragus clipping earphone 1 can be powered on for up to 18-20 hours, the power consumption of the control panel 60 is as low as 5 mA, and the tragus clipping earphone 1 have no amplifier, so the power consumption is small, so as to greatly improve the single use period of the tragus clipping earphone 1, so as to solve the user's electricity anxiety. And the weight of the tragus clipping earphone 1 is set to 16 g or less, no pressure, no heavy feeling, so as to solve the discomfort caused to the user by the weight of the earphone.

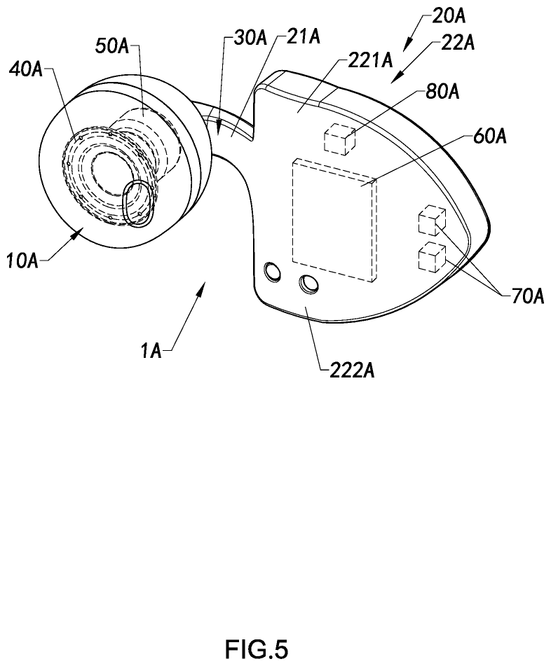

Referring to FIG. 5 of the drawings, a tragus clipping earphone 1A according to a second preferred embodiment of the invention is illustrated. The tragus clipping earphone 1A in this preferred embodiment is an alternative mode of the first preferred embodiment described above. Compared to the first preferred embodiment described above, in this embodiment a tragus clipping portion 20A is changed.

FIG. 5 is a perspective view illustrating an overall structure of a tragus clipping earphone 1A according to the second preferred embodiment of the present invention. In this embodiment, again, the tragus clipping earphone 1A comprises an cavum conchae wearing portion 10A, a speaker 40A, a power supply unit 50A, a control panel 60A, a control button 70A, a communication module 80A and has a clipping space 30A, the tragus clipping portion 20A is provided at the rear end of the cavum conchae wearing portion 10A, the cavum conchae wearing portion 10A is adapted to fit to an inner side of the wearer's tragus 802, the tragus clipping portion 20A is adapted to fit on an outer side of the wearer's tragus 802, the clipping space 30A is formed between the cavum conchae wearing portion 10A and the tragus clipping portion 20A, the wearer's tragus 802 is adapted to be placed in the clipping space 30A.

The speaker 40A is provided in the cavum conchae wearing portion 10A facing towards the ear canal of the wearer, the power supply unit 50A is provided in the cavum conchae wearing portion 10A, the control panel 60A is provided in the tragus clipping portion 20A, the control button 70A is provided on the outer surface of the tragus clipping portion 20A. When the tragus clipping earphone 1A is in use, the control button 70A is provided on the outer surface of the tragus clipping portion 20A, so that when the tragus clipping earphone 1A is in use, the control button 70A faces outwardly to facilitate touching and pressing by the wearer, and the communication module 80A is provided on the tragus clipping portion 20A suitable for receiving and transmitting signals.

Specifically, in this embodiment, the tragus clipping portion 20A comprises an connecting part 21A and a fixing part 22A, two ends of the connecting part 21A are respectively connected to the cavum conchae wearing portion 10A and the fixing part 22A. The fixing part 22A comprises an upper fixing portion 221A and a lower fixing portion 222A, the upper fixing portion 221A is extended upwardly from the cavum conchae wearing portion 10A, the lower fixing portion 222A is extended downwardly from the cavum conchae wearing portion 10A. The difference is that in this embodiment, the ends of the upper fixing portion 221A and the lower fixing portion 222A are provided to be connected in one piece, that is, the transverse length of the upper fixing portion 221A and the lower fixing portion 222A is increased compared to the above embodiment, so as to increase the transverse contact area of the upper fixing portion 221A and the lower fixing portion 222A with the outer side of the tragus 802 of the wearer, and thus making the tragus clipping earphone 1A to be worn more securely on the human ear.

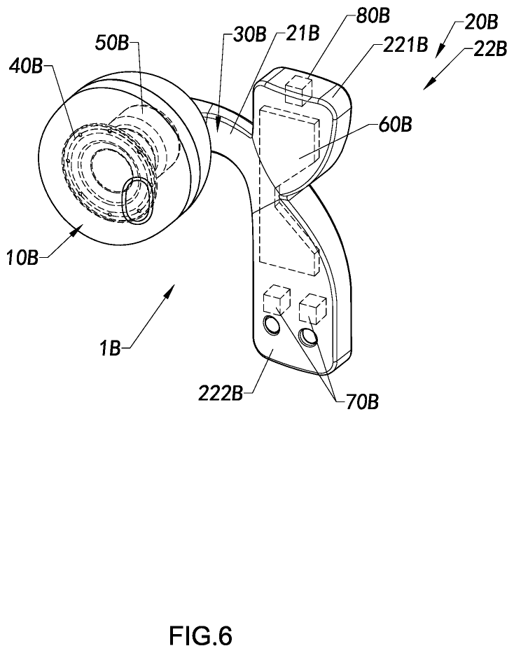

Referring to FIG. 6 of the drawings, a tragus clipping earphone 1B according to a third preferred embodiment of the present invention is illustrated, in which the tragus clipping earphone 1B is an alternative mode of the first preferred embodiment described above. Compared to the first preferred embodiment described above, in this embodiment, the tragus clipping portion 20B is changed.

In this embodiment, the cavum conchae wearing portion 10B, the clipping space 30B, the speaker 40B, the power supply unit 50B, the control panel 60B, the control button 70B and the communication module 80B are all identical to the cavum conchae wearing portion 10, the clipping space 30, the speaker 40, the power supply unit 50, the control panel 60, the control buttons 70 and the communication module 80 of the above embodiment, therefore, this is not repeated in the present embodiment.

FIG. 6 is a perspective view illustrating an overall structure of a tragus clipping earphone 1B according to the third preferred embodiment of the present invention. Specifically, in this embodiment, the tragus clipping portion 20B comprises a connecting part 21B and a fixing part 22B, two ends of the connecting part 21B are connected to the cavum conchae wearing portion 10B and the fixing part 22B. The fixing part 22B comprises an upper fixing portion 221B and a lower fixing portion 222B, the upper fixing portion 221B is extended upwardly from the cavum conchae wearing portion 10B, the lower fixing portion 222B is extended downwardly from the cavum conchae wearing portion 10B. Compared to the first embodiment described above, in this embodiment the length of the lower fixing portion 222B is provided to be greater than the length of the upper fixing portion 221B, so as to increase the contact area between the lower fixing portion 222B and the outer side of the wearer's tragus 802, that is, the longitudinal contact area between the lower fixing portion 222B and the outer side of the wearer's tragus 802 is increased, this allows the tragus clipping earphone 1B to be worn more securely on the human ear.

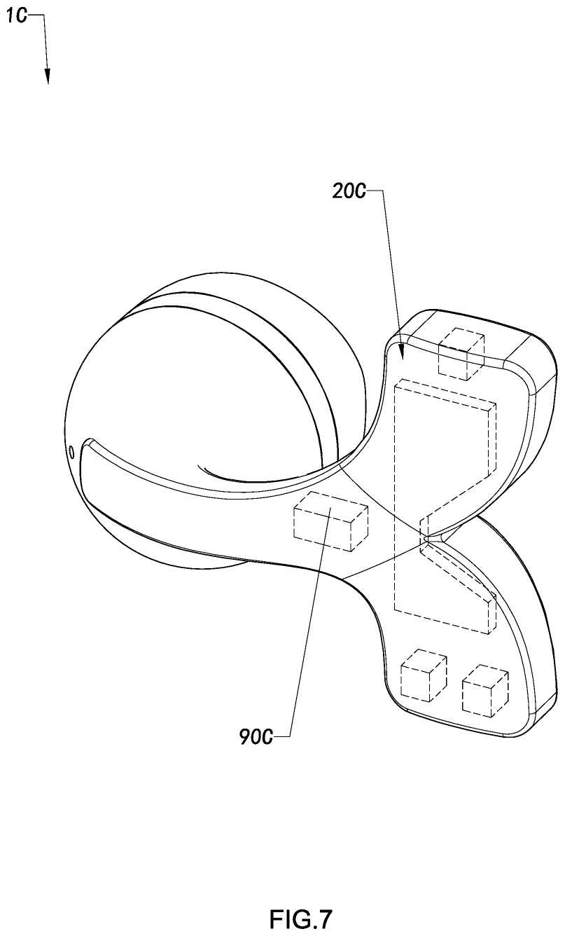

Referring to FIG. 7 of the drawings, a tragus clipping earphone 1C according to a fourth preferred embodiment of the present invention is illustrated, the tragus clipping earphone 1C in this preferred embodiment is an alternative mode of the first preferred embodiment described above.

FIG. 7 is a perspective view illustrating an overall structure of the tragus clipping earphone 1C according to the fourth preferred embodiment of the present invention. Specifically, compared to the first preferred embodiment described above, in this embodiment, the tragus clipping earphone 1C further comprises a hearing aid module 90C which is provided in the tragus clipping portion 20C. The hearing aid module 90C is adapted to help a hard-of-hearing user to hear external sounds. The hearing aid module 90C is provided in the tragus clipping portion 20C and comprises a microphone, an amplifier, a receiver and other structures, wherein the microphone is used to collect sound into electrical waves, the amplifier is used to increase the strength of the electrical waves and the receiver is used to convert the electrical waves back into sound waves.

For example, some older users need to wear hearing aids to assist them in listening to sound, and for this reason it is often necessary to change the earphones and hearing aids, which is very inconvenient. In this embodiment, the tragus clipping earphone 1C is combined with a hearing aid, that is, the tragus clipping earphone 1C is equipped with the hearing aid module 90C, which is able to be switched freely for allowing the wearer to receive phone calls or listen to voices of other people by the hearing aid module 90C.

Based on this, the tragus clipping earphone 1C has a headphone function and a hearing aid function. Specifically, when a call is came, the tragus clipping earphone 1C is connected via Bluetooth by switching to the headphone function. Normally it can be switched to the hearing aid function and used as a hearing aid, so as to make it easier for the user with poor hearing to wear it and avoiding the trouble caused by replacing the tragus clipping earphone 1C with the hearing aid. In other words, the hearing aid of the present invention has the function of answering electronic devices.

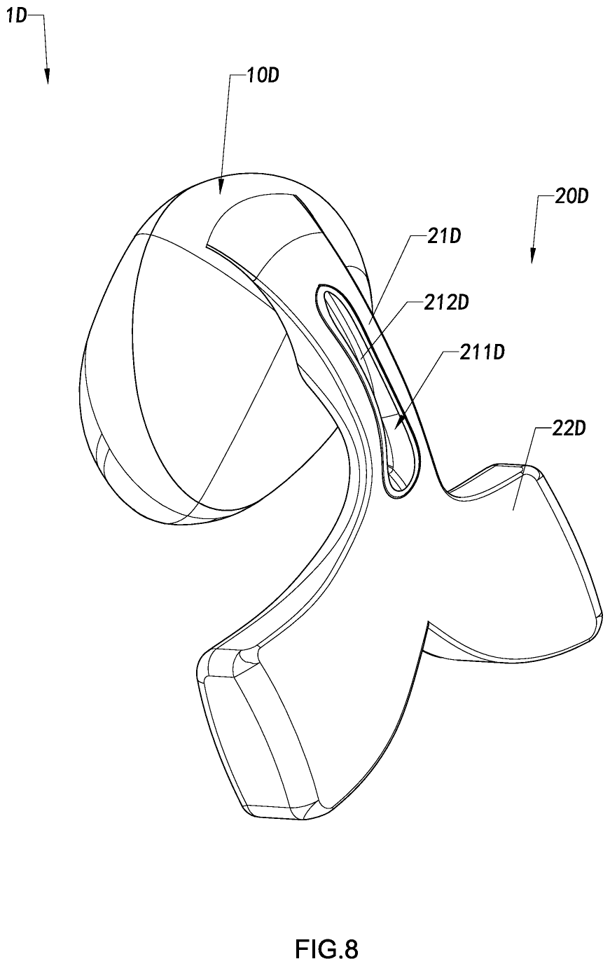

Referring to FIG. 8, a tragus clipping earphone 1D according to a fourth preferred embodiment of the invention is illustrated, in which the tragus clipping earphone 1D is an alternative mode of the first preferred embodiment described above. Compared to the first preferred embodiment described above, in this embodiment, the tragus clipping portion 20D of the tragus clipping earphone 1D is changed.

Similarly, the tragus clipping portion 20D comprises a connecting part 21D and a fixing part 22D, the fixing part 22D is integrally connected to the rear end of the connecting part 21D, the connecting part 21D is connected to the outer side of the cavum conchae wearing portion 10D. In other words, two sides of the connecting part 21D are respectively connected to the fixing part 22D and the cavum conchae wearing portion 10D. specifically, the connecting part 21D is extended at a predetermined angle from the outer side of the cavum conchae wearing portion 10D towards the rear end thereof.

FIG. 8 is a perspective view illustrating an overall structure of the tragus clipping earphone 1D according to the fourth preferred embodiment of the present invention. Specifically, in this embodiment, the connecting part 21D has a connecting slot 211D which is inwardly recessed from the outer side of the connecting part 21D, wherein the connecting slot 211D does not penetrate the connecting part 21D. In this embodiment, the connecting slot 211D is used for the passage of the wires 212D of the tragus clipping earphone 1D. In other words, the connecting slot 211D provides a mounting channel for the wires 212D of the tragus clipping earphone 1D, so that the wires 212D can be received in the connection slot 211D and extended from the tragus clipping portion 20D to the cavum conchae wearing portion 10D.

More specifically, the connection slot 211D of the connection part 21D can be provided in a different shape, which can be selected according to the user's needs. Furthermore, the wires 212D of tragus clipping earphone 1D can be selected in colour and style and so on according to the user's needs, so that when the tragus clipping earphone 1D is worn by the user, the wires 212D of the tragus clipping earphone 1D is suitable to be exposed from the connection slot 211D, so as to increase the aesthetics of the tragus clipping earphone 1D.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A tragus clipping earphone, comprising:
a cavum conchae wearing portion for being placed at a position at an inner side of a tragus of a wearer corresponding to a cavum conchae of the wearer; and
a tragus clipping portion for being fitted on an outer side of the wearer's tragus, wherein said tragus clipping portion is connected to said cavum conchae wearing portion, and a clipping space is formed between said cavum conchae wearing portion and said tragus clipping portion, and the wearer's tragus is adapted to be held in said clipping space and positioned between said cavum conchae wearing portion and said tragus clipping portion.

2. The tragus clipping earphone, as recited in claim 1, wherein said tragus clipping portion comprises a connecting part and a fixing part, two ends of said connecting part are respectively connected to said cavum conchae wearing part and said fixing part, wherein said fixing part is capable of being fitted on the outer side of the tragus of the wearer.

3. The tragus clipping earphone, as recited in claim 2, wherein said fixing part comprises an upper fixing portion and a lower fixing portion, said upper fixing portion is upwardly extended from said cavum conchae wearing portion and said lower fixing portion is downwardly extended from said cavum conchae wearing portion.

4. The tragus clipping earphone, as recited in claim 1, wherein said tragus clipping earphone further comprises a speaker and a power supply unit, said power supply unit is provided in said tragus clipping portion, said speaker is provided in said cavum conchae wearing portion, said speaker is facing towards an ear canal of the wearer when said tragus clipping earphone is worn on the wearer.

5. The tragus clipping earphone, as recited in claim 4, wherein said tragus clipping earphone further comprises a control panel and at least one control button, said control panel is provided in said tragus clipping portion and said control button is provided on an outer surface of said tragus clipping portion.

6. The tragus clipping earphone, as recited in claim 1, wherein said tragus clipping earphone further comprises a speaker and a control panel, said speaker and said control panel are provided in said cavum conchae wearing portion, said speaker is facing towards the ear canal of the wearer when said tragus clipping earphone is worn on the wearer.

7. The tragus clipping earphone, as recited in claim 5, wherein said tragus clipping earphone further comprises a communication module which is disposed in said tragus clipping portion, said communication module is electrically connected to said power supply unit and said control panel.

8. The tragus clipping earphone, as recited in claim 7, wherein said tragus clipping portion is made of elastic material or rigid material.

9. The tragus clipping earphone according to claim 8, wherein said tragus clipping earphone further comprises a microphone which is provided on said tragus clipping portion.

10. The tragus clipping earphone, as recited in claim 1, wherein said cavum conchae wearing portion comprises a body portion and a cover portion, said cover portion is detachably mounted to said body portion, said body portion is connected to said tragus clipping portion.

11. The tragus clipping earphone, as recited in claim 10, wherein said tragus clipping earphone further comprises a decorative unit which is mounted on at least one of said body portion of said cavum conchae wearing portion and said tragus clipping portion.

12. The tragus clipping earphone, as recited in claim 1, further comprising a hearing aid module such that said tragus clipping earphone combines the function of a hearing aid with the function of an earphone.

13. The tragus clipping earphone, as recited in claim 1, wherein said tragus clipping earphone is configured as a terminal device for intelligent voice interaction.

14. The tragus clipping earphone, as recited in claim 1, wherein said tragus clipping earphone further comprises a speaker and a control panel, wherein said speaker is provided in said cavum conchae wearing portion, said speaker is facing towards an ear canal of the wearer when said tragus clipping earphone is worn on the wearer, said control panel is provided in said tragus clipping portion.

15. The tragus clipping earphone, as recited in claim 14, wherein said power supply unit is provided in one of said cavum conchae wearing portion and said tragus clipping portion.

16. The tragus clipping earphone, as recited in claim 2, wherein said connecting part comprises wires and a connection slot, wherein said wires are disposed in said connecting slot.

17. The tragus clipping earphone, as recited in claim 2, wherein said connection slot is recessed along said connecting part, wherein said wires disposed in said connecting slot are exposed.

18. The tragus clipping earphone, as recited in claim 11, wherein said decorative unit comprises a plurality of dotted decorations or a strip of decorations which is provided by a diamond inlaying process or an engraving process.

19. The tragus clipping earphone, as recited in claim 10, wherein said body portion and said tragus clipping portion is made of a material selected from the group consisting of copper, silver, stainless steel, K-gold and gold, wherein said tragus clipping earphone further comprises a decorative unit which is mounted on at least one of said body portion of said cavum conchae wearing portion and said tragus clipping portion.

20. The tragus clipping earphone, as recited in claim 10, wherein said body portion and said tragus clipping portion is made of a material selected from the group consisting of copper, silver, stainless steel, K-gold, gold, ABS material, PP material, PC material, rubber, and silicone.
